(19) United States
(12) Patent Application Publication
(10) Pub. No.: US 2016/0151923 A1
(43) Pub. Date: Jun. 2, 2016

(54) HAIR CLIPPER AND METHOD OF FORMING THE SAME

(71) Applicant: Justin Robert Sisson, Phoenix, AZ (US)

(72) Inventor: Justin Robert Sisson, Phoenix, AZ (US)

(21) Appl. No.: 14/882,224

(22) Filed: Oct. 13, 2015

Related U.S. Application Data
(60) Provisional application No. 62/123,839, filed on Dec. 1, 2014.

(51) Int. Cl. B26B 19/38; B26B 19/06

(52) U.S. Cl. CPC B26B 19/388; B26B 19/063; B26B 19/3813

(57) ABSTRACT

Disclosed is a hair clipper with a moveable guard. The guard is moveably coupled to a clipper body of the hair clipper, such that the distance between the guard and a set of blades is adjustable. The distance between the guard and the set of blades determines how close the set of blades gets to the skull, which determines how short the hair is cut. The distance between the guard and the set of blades on the disclosed hair clipper is adjustable using control buttons on the clipper body. Activating one of the control buttons moves the guard a specific distance from the set of blades. This allows the user of the hair clipper to adjust the distance between the guard and the set of blades by pressing a control button, instead of by removing and replacing guards on the clipper.

### CROSS REFERENCE TO RELATED APPLICATIONS

This application claims priority to U.S. patent application Ser. No. 62/123,839, filed Dec. 1, 2014, by Justin Robert Sisson, and entitled “J-Sisson digital guard hair clippers”, which is incorporated herein by reference in its entirety.

### BACKGROUND OF THE INVENTION

1. Technical Field

This invention relates to tools for cutting hair, and in particular to a hair clipper with a moveable guard.

2. State of the Art

Electric hair clippers are in common use for cutting hair. Electric hair clippers commonly include a set of blades which cut the hair. The cut length—the length of hair after it is cut—is determined by the distance between the set of blades and the scalp. In order to adjust the distance between the set of blades and the scalp, a set of guards are used that each individually mechanically couple to the hair clipper. Each guard is designed to position the set of blades a fixed specific distance from the scalp. The set of fixed-distance guards includes guards with a range of fixed distances, which provide for a range of haircut lengths. The barber/hair stylist chooses the fixed-distance guard that corresponds to the length of hair desired, and mechanically switches one guard for another when it is necessary to adjust the cut length. Because it is necessary to mechanically remove one fixed-distance guard and put another one in place on the clippers each time it is desired to adjust the cut length, barbers are continually removing one guard and replacing it with another.

Accordingly, what is needed is a hair clipper with a guard that moves relative to the set of blades so that the distance between the guard and the set of blades is adjustable without having to replace the guard.

### BRIEF DESCRIPTION OF THE DRAWINGS

FIG. 1 shows a perspective view of a hair clipper;

FIG. 2 shows a side view and a front view of a guard as used on the hair clipper of FIG. 1;

FIG. 3 shows a simplified illustration of the hair clipper of FIG. 1 cutting hair;

FIG. 4 shows a side view of the hair clipper of FIG. 1;

FIG. 5 shows a top view of the hair clipper of FIG. 1;

FIG. 6 shows a simplified block diagram of the hair clipper of FIG. 1; and

FIG. 7 illustrates a method of forming a hair clipper.

### DETAILED DESCRIPTION OF EMBODIMENTS OF THE INVENTION

As discussed above, embodiments of the present invention relate to tools for cutting hair, and in particular to a hair clipper with a moveable guard. The guard is moveably coupled to a clipper body of the hair clipper such that the distance between the guard and the set of blades is adjustable. The distance between the guard and the set of blades determines how close the set of blades gets to the skull, which determines how short the hair is cut. The distance between the guard and the set of blades on the disclosed hair clipper is adjustable using control buttons on the clipper body. Activating one of the control buttons moves the guard a specific distance from the set of blades. This allows the user of the hair clipper to adjust the distance between the guard and the set of blades by pressing a control button, instead of by removing and replacing guards on the clipper.

Electric hair clippers are in common use for cutting hair. Electric hair clippers include a set of blades which cut the hair. The electric hair clipper is held near the scalp such that the hair to be cut comes in contact with the set of blades, and is cut by the set of blades. The closer the set of blades are held to the scalp, the shorter the hair is cut. It is difficult for a user of the hair clipper to hold the hair clipper a consistent distance from the scalp without mechanical aid. Without this mechanical aid, the hair clipper will move towards and away from the scalp as the hair is being trimmed, resulting in an uneven cut.

In order to accurately and consistently set the distance between the set of blades and the scalp, a set of fixed-distance guards are often used by barbers and hair stylists. Each fixed-distance guard is designed to position the set of blades a specific distance from the scalp. Thus, each fixed-distance guard results in a specific cut length. A set of fixed-distance guards includes a guard designed for each of a range of cut lengths. Each fixed-distance guard individually mechanically couples to the hair clipper. The barber/hair stylist chooses the fixed-distance guard that corresponds to the desired hair length, and mechanically switches one fixed-distance guard for another when it is necessary to adjust the hair length. Because it is necessary to mechanically remove one fixed-distance guard and put another one in place on the hair clipper each time it is desired to adjust the hair length, users of hair clippers are continually removing one guard and replacing it with another. This constant switching of fixed-distance guards is tedious, time consuming, and is not conducive to obtaining a smooth cut length transition.

This disclosed hair clipper includes a guard that is moved via a set of control buttons on the hair clipper body. The distance between the moveable guard and the set of blades is determined by activating one of the control buttons, instead of installing a specific guard with a fixed distance. The distance between the guard and the set of blades can be changed while the user is cutting hair, resulting in smooth cut length transitions and less time and hassle in mechanically removing one guard and installing another.

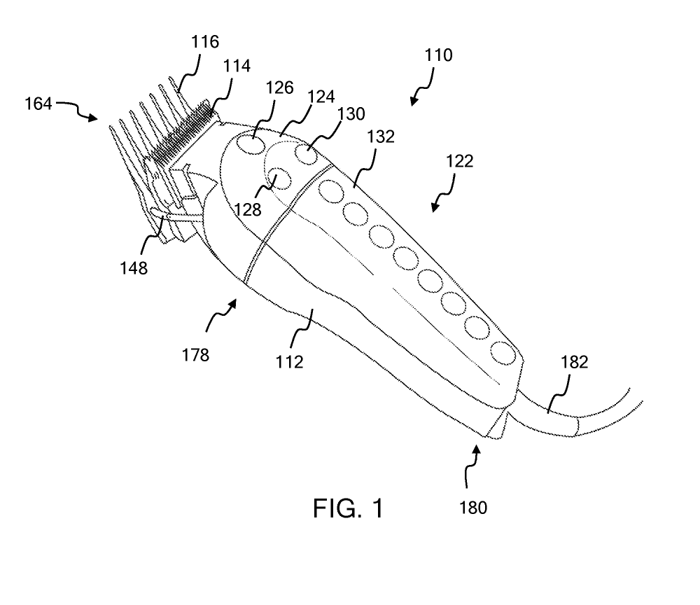

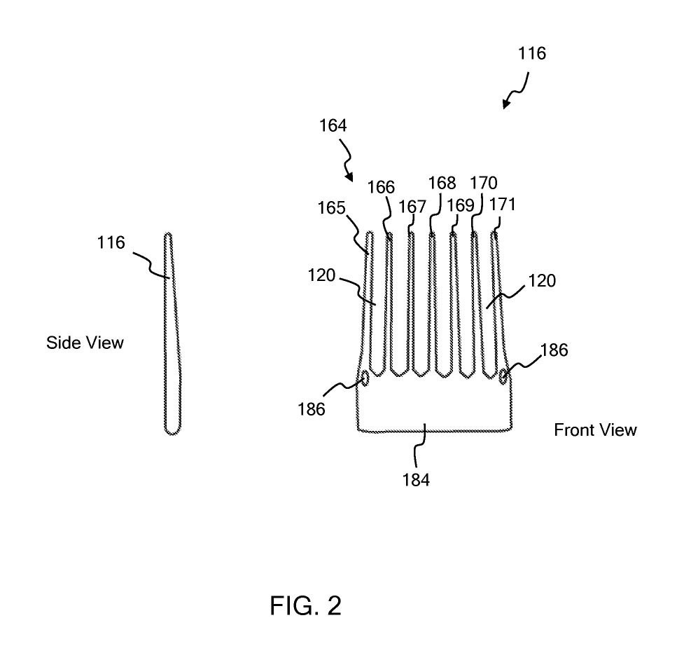

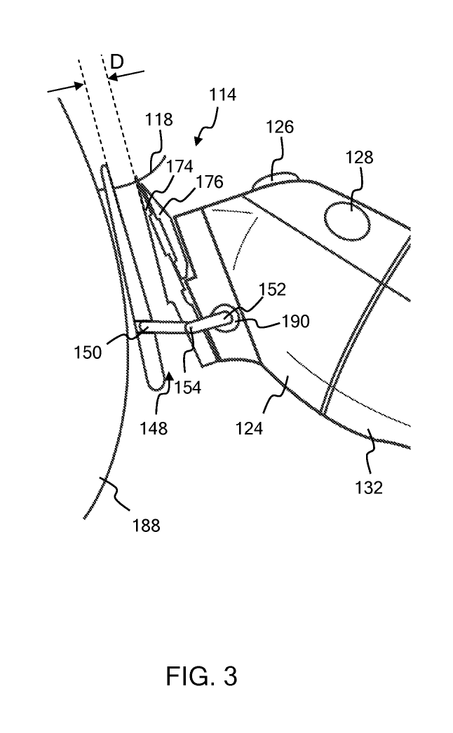

FIG. 1 shows a perspective view of a hair clipper 110 with a moveable guard 116. FIG. 2 shows a side view and a front view of guard 116. FIG. 3 shows a side view close-up of clippers 110 cutting a hair 118 growing from a scalp 188.

Referring back to FIG. 1, hair clipper 110 includes a clipper body 112, a set of blades 114, and guard 116. Set of blades 114 can be any blades used now or in the future on hair clippers for cutting hair. In this embodiment set of blades 114 includes two blades, a first blade 174 and a second blade 176 (see FIG. 3). Set of blades 114 is coupled to clipper body 112 as is known in the art of hair clippers. Clipper body 112 is held in the hand to move set of blades 114 into position to cut hair.

Guard 116 is coupled to clipper body 112. Guard 116 is coupled to clipper body 112 so that guard 116 is adjacent set of blades 114, with set of blades 114 positioned between guard 116 and clipper body 112. FIG. 2 shows details of guard 116. Guard 116 includes a guard base 184 and a plurality of tines 164 extending from guard base 184. In this embodiment there are seven tines, a tine 165, a tine 166, a tine 167, a tine 168, a tine 169, a tine 170, and a tine 171. In between each one of plurality of tines 164 is a slot 120 (not all slots 120 are numbered in FIG. 2). As shown in FIG. 3, guard 116 is coupled to clipper body 112 such that hair 118 to be cut passes between two of the plurality of tines 164, through a slot 120, to reach set of blades 114. Guard 116 also includes a pair of guard arm coupling holes 186, which are used to couple guard 116 to clipper body 112 in this embodiment.

Guard 116 is held against the scalp 188 as shown in FIG. 3, and maintains the distance between scalp 188 and set of blades 114 that is desired to get the desired cut length. Guard 116 is different from fixed-distance guards that have been in use because guard 116 moves with respect to set of blades 114, so that guard 116 can handle a range of distances and corresponding cut lengths. Guards that have been in common use until now, which are referred to as fixed-distance guards herein, have a single distance between guard and blades for each fixed-distance guard. Each fixed-distance guard is used for a single cut length, and to change the cut-length, the fixed-distance guard needs to be changed to another fixed-distance guard. Guard 116 has an adjustable distance D between guard 116 and set of blades 114, so guard 116 can be used for a range of cut lengths without changing guard 116.

Guard 116 is moveably, mechanically coupled to clipper body 112 so that a distance D between set of blades 114 and guard 116 is adjustable. Thus, guard 116 is movable relative to set of blades 114. Distance D is adjusted by mechanically moving guard 116 towards and away from set of blades 114. The mechanical movement of guard 116 is electronically controlled, as will be explained herein. This makes adjusting the position of guard 116, and distance D, easy to perform while using hair clipper 110.

It is to be understood that guard 116 can take many shapes and forms, and have many different quantities and shapes of tines and slots. Any shape, form and size of guard 116 can be used that can be moveably coupled to clipper body 112 and have an adjustable distance D between guard 116 and set of blades 114.

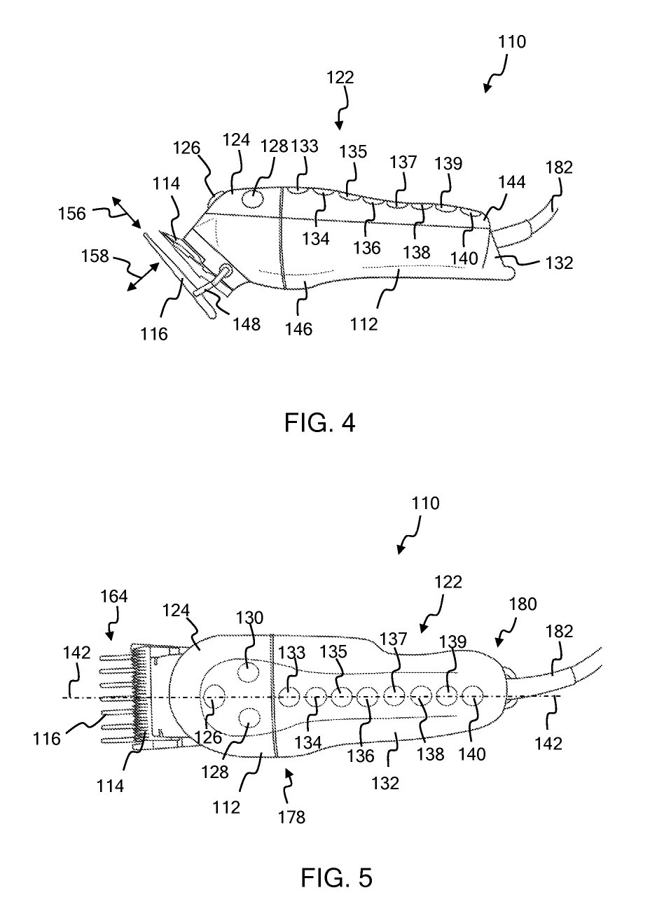

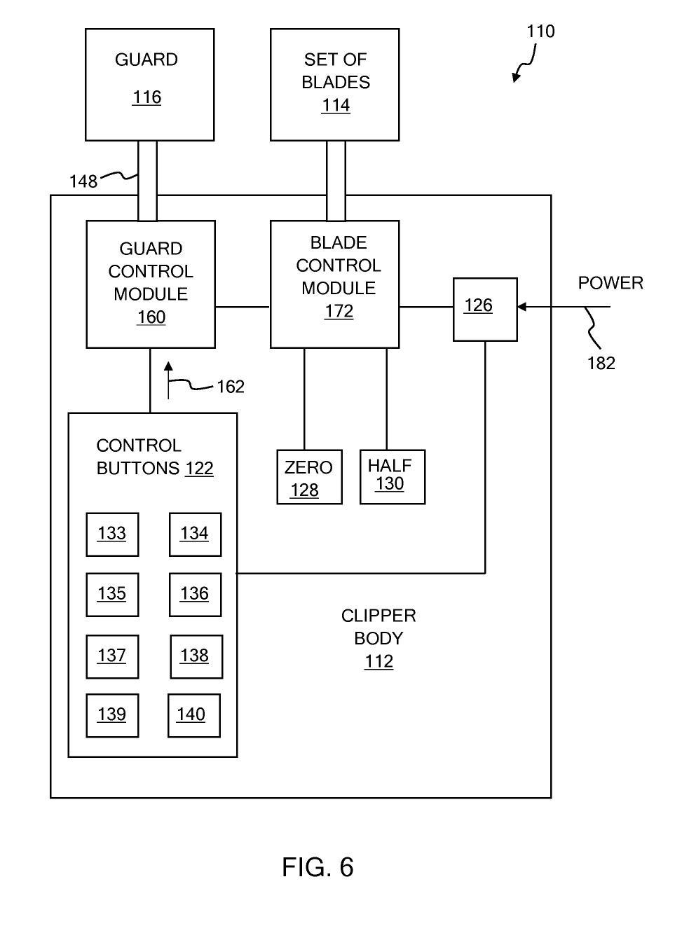

FIG. 4 through FIG. 6 show additional details of clipper 110. FIG. 4 shows a side view of clipper 110. FIG. 5 shows a top view of clipper 110. FIG. 6 shows a simplified block diagram of clipper 110.

Clipper body 112 includes clipper body head portion 124, and clipper body shank portion 132, see FIG. 1, FIG. 4, and FIG. 5. Set of blades 114 and guard 116 are both coupled to clipper body head portion 124 such that set of blades 114 is positioned between guard 116 and clipper body head portion 124, best seen in FIG. 3 and FIG. 4.

Guard 116 is mechanically and adjustably coupled to clipper body head portion 124 with a pair of guard arms 148, as shown in FIG. 1, FIG. 3, and FIG. 4. Only one guard arm 148 is seen in the figures, but there is a corresponding guard arm 148 on the other side of clipper 110. Guard arms 148 mechanically and adjustably couple guard 116 to clipper body head portion 124 so that distance D between guard 116 and set of blade 116 is adjustable. Guard arm 148 can be adjustably coupled to clipper body head portion 124 in many ways. In this embodiment, guard arms 148 are retractable into clipper body head portion 124 through guard arm openings 190 (only one visible in FIG. 4). Each guard arm 148 includes a guard arm first portion 150, a guard arm second portion 152, and a guard arm joint 154, as shown in FIG. 3. Guard arm joint 154 is a retractable joint, because guard arm 148 and guard arm joint 154 can be retracted into clipper body head portion 124. Guard arm 148 bends at guard arm joint 154. Bending guard arm 148 at joint 154 allows for flexibility in moving guard 116 by guard arm 148.

Guard arm 148 in this embodiment moves guard 116 in two directions, as shown in FIG. 4. Guard arm 148 moves guard 116 in a first direction 156 parallel to set of blades 114. And guard arm 148 moves guard 116 in a second direction 158 perpendicular to set of blades 114. Guard arm 148 moving guard 116 in second direction 158 perpendicular to set of blades 114 adjusts distance D between guard 116 and set of blades 114. Being able to move guard 116 in at least two directions 156 and 158 provides for greater flexibility of guard 116 placement between set of blades 114 and scalp 188, giving the user of hair clipper 110 greater cutting options. In some embodiments, guard arm 148 rotates guard 116 to provide even greater flexibility and movement of guard 116 with respect to set of blades 114. In some embodiments, guard arm 148 rotates guard 116 at guard joint 154.

In the embodiment shown in the figures, guard arm 148 is coupled to guard 116 using guard arm coupling holes 186 (FIG. 2), but this is not meant to be limiting. It is to be understood that guard 116 can be moveably coupled to clipper body 112 in many different ways. Any apparatus that couples guard 116 to clipper body 112 and/or clipper body head portion 124 such that guard 116 moves with respect to set of blades 114, adjusting distance D between guard 116 and set of blades 114, can be used for clipper 110.

In the embodiment of hair clipper 110 shown in the figures, the movement of guard 116 by guard arm 148 is electronically controlled. The movement of guard arm 148 is electronically controlled by a guard control module 160 (FIG. 6), which receives electronic instructions on moving guard 116 from a plurality of control buttons 122, as shown in FIG. 1, FIG. 4, FIG. 5, and FIG. 6. FIG. 6 shows a simplified block diagram of hair clipper 110, showing the interconnection of the mechanical and electrical elements. As will be explained in more detail below, guard control module 160 receives an electronic guard distance control signal 162 from plurality of control buttons 122. Guard distance control signal 162 instructs guard control module 160 in which direction and how much to move guard 116 with respect to set of blades 114. Guard distance control module 160 mechanically moves guard 116 in response to receiving guard distance control signal 162 from plurality of control buttons 162.

Hair clipper 110 includes three control buttons 126, 128, and 130 on clipper body head portion 124, and plurality of control buttons 122 on clipper body shank portion 132. Control button 126 is a power button in this embodiment. Activating power control button 126 in this embodiment turns hair clipper 110 on, and provides power from power cord 182 to hair clipper 110. Control buttons 126, 128, and 130, and plurality of control buttons 122 in this embodiment are two-position, touch-activated pushbuttons, with an “on” position and an “off” position. To activate a control button in this document means putting the control button in the “on” position. In the embodiment shown in the figures, control buttons 126, 128, and 130, and plurality of control buttons 122 each are backlit with blue light to make the buttons easy to see. In some embodiments these buttons are not backlit, or are backlit using other colors of light. It is to be understood that many different types of control buttons or switches can be used to activate the different features and change a control or button from an “on” state to an “off” state as is known in the art. The pushbutton control buttons used here are examples only and are not meant to be limiting. It is also to be understood that many different placements and positions of control buttons on clipper body 112 can be used, depending on the specific design of a hair clipper.

Control button 128 is a zero blade control button in this embodiment, and control button 130 is a half blade control button. Zero blade control button 128 and half blade control button 130 toggle first and second blade 174 and 176 between a zero taper level position and a half taper level position. This adjustment of first blade 174 and second blade 176 is usually accomplished with a mechanical lever in hair clippers. Adjusting first blade 174 and second blade 176 between the zero taper level position and the half taper level position changes the distance between first blade 174 and second blade 176, often by about a half a millimeter, but this is not meant to be limiting. Thus, control button 128 and control button 130 control the distance between first blade 174 and second blade 176. In hair clipper 110, this adjustment of the distance between first and second blade 174 and 176 is electronically controlled using control buttons 128 and 130.

Zero blade control button 128 is mechanically coupled to clipper body head portion 124, as shown in the figures. Zero blade control button 128 is electrically coupled to a blade control module 172, as shown in FIG. 6. Blade control module 172 places set of blades 114, including first blade 174 and second blade 176, in a zero taper level position in response to zero blade control button 128 being activated.

Half blade control button 130 is mechanically coupled to clipper body head portion 124, as shown in the figures. Half blade control button 130 is electrically coupled to blade control module 172, as shown in FIG. 6. Blade control module 172 places set of blades 114, including first blade 174 and second blade 176, in a half taper level position in response to half blade control button 128 being activated.

Plurality of control buttons 122 are attached (mounted, coupled) to clipper body shank portion 132, as shown in FIG. 1, FIG. 4, and FIG. 5. Plurality of control buttons 122 on clipper body 112 controls distance D between guard 116 and set of blades 114. In this embodiment, plurality of control buttons 122 includes eight control buttons, including a control button 133, a control button 134, a control button 135, a control button 136, a control button 137, a control button 138, a control button 139, and a control button 140. Each one of plurality of control buttons 122 represents a different distance D between guard 116 and set of blades 114. The user of hair clipper 110 activates the one of plurality of control buttons 122 which represents the cut length desired, which results in guard 116 moving to adjust distance D for that cut length.

For example, in this embodiment, control button 136 represents a cut length of ½ inch. And control button 137 represents a cut length of ⅝ inch. A hairstylist using clipper 110 to cut hair wishes to have a cut length of ½ inch, and so activates control button 136. Guard 116 moves a distance D from set of blades 114 that results in a cut length of ½ inch, in response to control button 136 being activated. The hairstylist now wishes to transition to a ⅝ inch cut length, and so activates control button 137. Guard 116 moves with respect to set of blades 114 to a distance D that results in a cut length of ⅝ inch. The change of cut length is accomplished quickly and easily by electronic control instead of the user having to stop the hair clipper to change fixed-distance guards.

Each one of plurality of control buttons 122 represents a different position of guard 116, and a different distance D between guard 116 and set of blades 114, that results in a different cut length for each one of plurality of control buttons 122. It is to be understood that there can be different numbers and positions of plurality of control buttons 122, and that the resulting distance D and resulting cut length for any specific one of plurality of control buttons 122 can be designed specifically for a specific hair clipper 110, and does not need to be as described in this document.

In the embodiment shown in the figures, plurality of control buttons 122 are arranged in a line 142 extending longitudinally along a shank top side 144 as shown in FIG. 4 and FIG. 5. Longitudinal line 142 extends from a blade end 178 of clipper body shank portion 132 to a cord end 180 of clipper body shank portion 132. Arranging plurality of control buttons 122 along longitudinal line 142 makes for easy activation of plurality of control buttons 122 while hair clipper 110 is being used.

Plurality of control buttons 122 in this embodiment electronically control distance D between guard 116 and set of blades 114. Plurality of control buttons 122 are each electrically coupled to guard control module 160, as shown in FIG. 6. Plurality of control buttons 122 send guard control distance signal 162 to guard control module 160. Guard control distance signal 162 indicates which of plurality of control buttons 122 have been activated. Guard control module 160 mechanically adjusts distance D between guard 116 and set of blades 114 in response to receiving guard control signal 162 from plurality of control buttons 122.

FIG. 6 shows a simplified block diagram of hair clipper 110. Hair clipper 110 includes clipper body 112, with guard 116 and set of blades 114 mechanically coupled to clipper body 112. Guard 116 is mechanically coupled to clipper body 112 with guard arm 148, as explained earlier. Guard arm 148 adjusts distance D (FIG. 3) between guard 116 and set of blades 114. Guard arm 148 is controlled by guard control module 160. Guard control module 160 receives guard distance control signal 162 from plurality of control buttons 122. Guard distance control signal 162 tells guard control module 160 what distance D to adjust guard 116 from set of blades 114, in response to one of plurality of control buttons 122 being activated.

Power to hair clipper 110 is supplied by power cord 182 and turned on and off by power button 126. Blade control module 172 controls the distance between first blade 174 and second blade 176 (FIG. 3), in response to the activation of either zero blade control button 128 or half blade control button 130 as explained above.

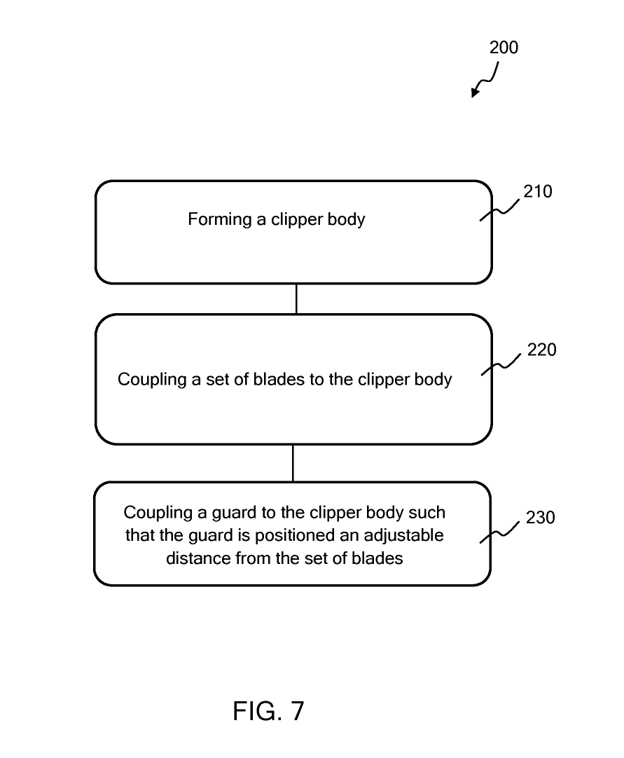

FIG. 7 illustrates method 200 of forming a hair clipper. Method 200 of forming a hair clipper includes a step 210 of forming a clipper body. Method 200 of forming a hair clipper also includes a step 220 of coupling a set of blades to the clipper body. And method 200 of forming a hair clipper includes a step 230 of coupling a guard to the clipper body such that the guard is positioned an adjustable distance from the set of blades. In some embodiments, coupling a guard to the clipper body includes coupling the guard to the clipper body using a retractable guard arm.

Method 200 can include many other steps In some embodiments, method 200 includes the step of coupling a plurality of control buttons to the clipper body, where the plurality of control buttons control the adjustable distance between the guard and the set of blades. In some embodiments, the set of blades includes a first blade and a second blade, and method 200 also includes a step of coupling a pair of control buttons to a clipper body head portion, where the pair of control buttons controls the distance between the first blade and the second blade.

In some embodiments, method 200 also includes attaching three control buttons to a clipper body head portion of the clipper body, where the three control buttons comprise a power button, a zero blade control button, and a half blade control button. In some embodiments, method 200 also includes attaching eight control buttons to a clipper body shank portion of the clipper body, wherein the eight control buttons control the adjustable distance between the guard and the set of blades. In some embodiments, attaching eight control buttons to the clipper body shank portion of the clipper body includes attaching eight control buttons to a top side of the clipper body shank portion along a longitudinal line extending from a blade end of the clipper body shank portion to a cord end of the clipper body shank portion.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A hair clipper comprising:
a clipper body;
a set of blades coupled to the clipper body; and
a guard coupled to the clipper body adjacent the set of blades such that hair passes through slots in the guard to reach the set of blades, and wherein a distance between the guard and the set of blades is adjustable.

2. The hair clipper of claim 1, wherein a plurality of control buttons on the clipper body controls the distance between the guard and the set of blades.

3. The hair clipper of claim 2, wherein a plurality of control buttons on the clipper body electronically controls the distance between the guard and the set of blades.

4. The hair clipper of claim 1, wherein the clipper body comprises:
a head portion, wherein the head portion has three control buttons; and
a shank portion, wherein the shank portion has eight control buttons.

5. The hair clipper of claim 4, wherein the eight control buttons on the shank portion are arranged in a line extending longitudinally along a top side of the shank portion.

6. The hair clipper of claim 3, wherein a guard arm mechanically couples the guard to the clipper body.

7. The hair clipper of claim 6, wherein the guard arm mechanically couples the guard to the clipper body such that the guard moves in a first direction parallel to the set of blades, and in a second direction perpendicular to the set of blades.

8. The hair clipper of claim 7, further comprising a guard control module, wherein the guard control module converts a guard distance control signal from the plurality of control buttons into a mechanical movement of the guard arm.

9. A hair clipper comprising:
a clipper body comprising a clipper body head portion and a clipper body shank portion;
a guard mechanically coupled to the clipper body head portion;
a set of blades mechanically coupled to the clipper body head portion, wherein the set of blades is positioned between the guard and the clipper body head portion;
a plurality of control buttons coupled to the clipper body shank portion; and
a guard control module electrically coupled to the plurality of control buttons, wherein the guard control module adjusts a distance between the guard and the set of blades in response to receiving a guard distance control signal from the plurality of control buttons.

10. The hair clipper of claim 9, wherein the guard comprises a plurality of tines, and wherein a hair to be cut passes between two of the plurality of tines to reach the set of blades.

11. The hair clipper of claim 9, further comprising a zero blade control button, wherein the zero blade control button is mechanically coupled to the clipper body head portion, and wherein the zero blade control button is electrically coupled to a blade control module, wherein the blade control module places the set of blades in a zero taper level position in response to the zero blade control button being activated.

12. The hair clipper of claim 11, further comprising a half blade control button, wherein the half blade control button is mechanically coupled to the clipper body head portion, and wherein the half blade control button is electrically coupled to the blade control module, wherein the blade control module places the set of blades in a half taper level position in response to the half blade control button being activated.

13. The hair clipper of claim 9, wherein the guard is mechanically coupled to the clipper body head portion with a guard arm, and wherein the guard control module moves the guard arm such that the guard moves in a first direction parallel to the set of blades.

14. The hair clipper of claim 13, wherein the guard control module moves the guard arm such that the guard moves in a second direction perpendicular to the set of blades.

15. A method of forming a hair clipper comprising:
forming a clipper body;
coupling a set of blades to the clipper body; and
coupling a guard to the clipper body such that the guard is positioned an adjustable distance from the set of blades.

16. The method of claim 15, further comprising coupling a plurality of control buttons to the clipper body, wherein the plurality of control buttons control the adjustable distance between the guard and the set of blades.

17. The method of claim 15, wherein the set of blades comprises a first blade and a second blade, and wherein the method further comprises coupling a pair of control buttons to a clipper body head portion, wherein the pair of control buttons controls the distance between the first blade and the second blade.

18. The method of claim 15, wherein the guard is coupled to the clipper body using a retractable guard arm.

19. The method of claim 15, further comprising:
attaching three control buttons to a clipper body head portion of the clipper body, wherein the three control buttons comprise a power button, a zero blade control button, and a half blade control button; and
attaching eight control buttons to a clipper body shank portion of the clipper body, wherein the eight control buttons control the adjustable distance between the guard and the set of blades.

20. The method of claim 19, wherein the eight control buttons are attached to a top side of the clipper body shank portion along a longitudinal line extending from a blade end of the clipper body shank portion to a cord end of the clipper body shank portion.
